(19) United States
(12) Patent Application Publication
(10) Pub. No.: US 2013/0291083 A1
(43) Pub. Date: Oct. 31, 2013

(54) WIRELESS SMART KEY DEVICE AND SIGNING METHOD THEREOF

(71) Applicants: Zhou Lu, Beijing (CN); Huazhang Yu, Beijing (CN)

(72) Inventors: Zhou Lu, Beijing (CN); Huazhang Yu, Beijing (CN)

(73) Assignee: FEITIAN TECHNOLOGIESCO., LTD, Beijing (CN)

(21) Appl. No.: 13/979,055

(22) PCT Filed: Apr. 28, 2012
(86) PCT No.: PCT/CN12/74891

§ 371 Date: Jul. 10, 2013

(30) Foreign Application Priority Data
May 31, 2011 (CN) 201110145162.0
May 31, 2011 (CN) 201110145282.0

(51) Int. Cl. H04L 9/32

(52) U.S. Cl. CPC H04L 9/32
USPC 726/7

(57) ABSTRACT

The disclosure discloses a wireless smart key device and signing method thereof. The wireless smart key device includes an online device and an offline device; the online device includes a serial communication interface, a first module and a first wireless receiving and sending module; the offline device includes a second module, a power module, a second wireless receiving and sending module, an information inputting module and an information outputting module. The signing method includes that the online device is powered up, receives transaction information message sent by a host computer and communicates with the offline device; the offline device obtains transaction information, outputs the transaction information, waits for receiving user operation information and receives the user operation information; the offline device communicates with the online device; the online device obtains operation result of processing the user operation; the online device sends corresponding operation result to the host computer.

### TECHNICAL FIELD

The disclosure relates to information security field, specifically relates to a smart key device which can work in wireless communication and a signing method thereof.

### BACKGROUND OF THE INVENTION

A smart key device is a portable device which provides information encryption processing by standard personal computer interface. With a built-in single chip microcomputer or a smart card chip, the smart key device can store key or digital certificate and implement functions, such as encrypting information or identity identification processing, with cipher algorithm built in the smart key device. The smart key device has functions such as PKI application, digital signing, information encryption, secure network logon, accessing SSL secure network, and the like, and has a feature that the private key of the user never leave hardware. In addition, the smart key device has the capabilities such as preventing its internal sensitive information from being obtained physically without authorization, etc.

At present, with popularization of e-bank, more and more people start to use the convenient and fast e-bank business. Currently an accepted solution to solve client security problem in e-bank is using digital certificate. The digital certificate used by e-bank generally is a USB Key. At present, the USB Key connects to a PC via a USB interface. In the process of using a USB Key with liquid crystal display and keys in the prior art, the USB Key connects with a host computer by the USB interface. A client needs to check information displayed on the USB Key and input password, which bring much inconvenience to actual operation. In order to solve the problem above, we are looking for a solution, which can separate the input display part of the USB Key and the host computer apart.

### SUMMARY OF THE INVENTION

In order to solve the technical problem above, the disclosure provides a smart key device comprising a wireless communication device and a signing method thereof. The smart key device is connected to a host computer by a serial communication interface; an online device and an offline device of the smart key device can communicate with each other by wired connection or wireless connection to perform data transmission.

In order to reach purpose above, according to one aspect of the present disclosure, a wireless smart key device is provided.

According to the present disclosure, the wireless smart key device comprises an online device and an offline device, wherein the online device comprises a serial communication interface, a first module and a first wireless receiving and sending module; the offline device comprises a second module, a power module, a second wireless receiving and sending module, an information inputting module and an information outputting module; the serial communication interface is connected to the first module and is configured to receive data sent by a host computer, transfer the data to the first module and send the data transferred from the first module to the host computer; the first wireless receiving and sending module is connected to the first module and is configured to send transaction information transferred from the first module to the second wireless receiving and sending module and transfer the data sent from the second wireless receiving and sending module to the first module; the second wireless receiving and sending module is connected to the second module and is configured to transfer the transaction information sent by the first wireless receiving and sending module to the second module and send the data transferred from the second module to the first wireless receiving and sending module;

the information inputting module is connected to the second module and is configured to receive user operation information and transfer the user operation information to the second module; the information outputting module is connected to the second module and is configured to receive the transaction information transferred from the second module and output the transaction information; the power module is connected to the second module and is configured to supply power to the offline device,

wherein, when the first module is a security module and the second module is a controller module, the security module is configured to receive data transferred from the serial communication interface, parse the received transaction information message, send the transaction information to the first wireless receiving and sending module, receive data transferred from the first wireless receiving and sending module, sign the transaction information message and send the signing result to the serial communication interface and store key; the controller module is configured to control the second wireless receiving and sending module to receive and send data, transfer the transaction information received from the second wireless receiving and sending module to the information outputting module and transfer the user operation information transferred from the information inputting module to the second wireless receiving and sending module,

or,

when the first module is the controller module, the second module is the security module, the controller module is configured to control the data transmission with the serial communication interface and control the first wireless receiving and sending module to receive and send data; the security module is configured to receive data transferred from the second wireless receiving and sending module, parse the transaction information message, send the transaction information to the information outputting module, receive the user operation information transferred from the information inputting module, sign the transaction information message, send signing result to the second wireless receiving and sending module and store key.

In order to reach the purpose above and according to another aspect of the present disclosure, a signing method of a wireless smart key device is provided.

According to the present disclosure, the signing method of wireless smart key device, comprising:

Step 101, an online device is powered up;

Step 102, the online device receives transaction information message sent by a host computer;

Step 103, the online device communicates with an offline device; the offline device obtains transaction information; Step 104, the offline device outputs the transaction information, and waits for receiving user operation information; Step 105, the offline device receives the user operation information; Step 106, the offline device communicates with the online device; the online device obtains operation result of processing the user operation; Step 107, the online device sends corresponding operation result to the host computer;

wherein, the step 103 comprises step S103′: the online device parses the transaction information out from the transaction information message; the online device sends the transaction information to the offline device; the offline device obtains the transaction information; correspondingly, the step 106 comprises step S106′: the offline device sends the received user operation information to the online device; the online device determines whether performing signing operation according to the received user operation information;

or,

the step 103 comprises step S103″: the online device sends the transaction information message to the offline device; the offline device parses the transaction information out from the received transaction information message; the offline device obtains the transaction information; correspondingly, the step 106 comprises step S106″: the offline device determines whether performing signing operation according to the received user operation information; the offline device sends corresponding operation result to the online device.

The advantages of the present disclosure is that, by using the wireless smart key device provided by the present disclosure, a client can take the display part and key part with him or her; when performing online transaction, the wireless smart key device is connected to a host computer, the instruction information transferred from the host computer can be easily read on the display part and corresponding key pressing operation is performed. Method of the present disclosure for realizing signing by using the wireless smart key device is flexible, various, safe and reliable.

### BRIEF DESCRIPTION OF THE DRAWINGS

FIG. 1 is a structure diagram of a wireless smart key device provided by embodiment 1;

FIG. 2 is a flow chart of a signing method of the wireless smart key device provided by embodiment 2;

FIG. 3 is a structure diagram of a wireless smart key device provided by embodiment 7; and

FIG. 4 is a flow chart of a signing method of the wireless smart key device provided by embodiment 8.

### DETAILED DESCRIPTION OF THE INVENTION

To make the purpose, technical solution and advantages of the present disclosure clearer, the present disclosure is further described in detail by reference to the accompanying drawings in conjunction with embodiments.

### Embodiment 1

In the present embodiment, a secure module of a wireless smart key device is located in an online device, an information inputting module and an information outputting module for rechecking transaction data are located in an offline device; the online device and the offline device can communicate with each other by wireless communication or wired communication. The online device can also be used as a signing device independently.

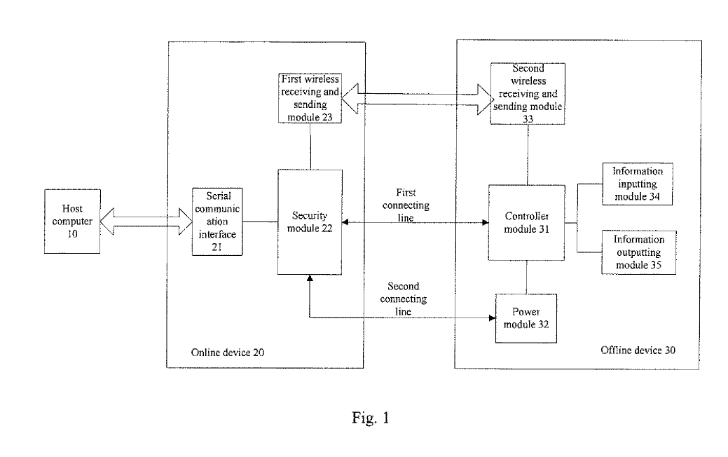

As shown by FIG. 1, the wireless smart key device includes an online device 20 and an offline device 30. The online device 20 includes a serial communication interface 21, a secure module 22 and a first wireless receiving and sending module 23. The offline device 30 includes a controller module 31, a power module 32, a second wireless receiving and sending module 33, an information inputting module 34 and an information outputting module 35. In this case, in the online device 20, the serial communication interface 21 and the first wireless receiving and sending module 23 are connected to the secure module 22 respectively; in the offline device 30, the power module 32, the second wireless receiving and sending module 33, the information inputting module 34, and the information outputting module 35 are connected to the controller module 31 respectively.

Further, the secure module 22 of the online device 20 can be connected to the controller module 31 of the offline device 30 by a first connecting line and be connected to the power module 32 of the offline device 30 by a second connecting line. The first wireless receiving and sending module 23 and the second wireless receiving and sending module 33 can adopt an nRF24L01+2.4G radio frequency receiver.

The functions of each module above are as follows.

The serial communication interface 21 is configured to receive data sent by a host computer, transfer the data to the secure module 22, and send the data transferred from the secure module 22 to the host computer. The serial communication interface 21 can be USB interface, serial interface, eSATA interface, 1394 interface, PCI_E interface, etc.

The secure module 22 is configured to receive data transferred from the serial communication interface 21, parse received transaction information message, send the transaction information to the first wireless receiving and sending module 23, receive data transferred from the first wireless receiving and sending module 23, sign the transaction information message and send the signing result to the serial communication interface 21, and store keys.

The first wireless receiving and sending module 23 is configured to receive transaction information transferred from the secure module 22 to the second wireless receiving and sending module 33, receive the data sent from the second wireless receiving and sending module 33 and transfer the data to the secure module 22.

The controller module 31 is configured to control the second wireless receiving and sending module 33 to receive and send data, transfer the transaction information received by the second wireless receiving and sending module 33 to the information outputting module 35 and transfer user operation information transferred from the information inputting module 34 to the second wireless receiving and sending module 33.

The power module 32 is configured to supply power for the offline device, which can adopt cells to supply power directly; the power module 32 also can be an external power interface by which the power module 32 can be connected to the host computer to charge the offline device; the external power interface can be a serial interface or a USB interface, etc. The power module 32 can be connected to the power side of the security module 22 by a second connecting line and can obtain power from the online device so as to supply power to the offline device by wired connection.

The second wireless receiving and sending module 33 is configured to receive the transaction information sent from the first wireless receiving and sending module 23 and transfer the transaction information to the controller module 31, and send the data transferred by the controller module 31 to the first wireless receiving and sending module 23.

The information inputting module 34 is configured to receive user operation information and transfer the user operation information to the controller module 31 by way of pressing keys, or inputting voice, etc.

The information outputting module 35 is configured to receive the transaction information transferred from the controller module 31 and output the transaction information; the information outputting module 35 can be a liquid crystal display, a voice announcer, etc.

### Embodiment 2

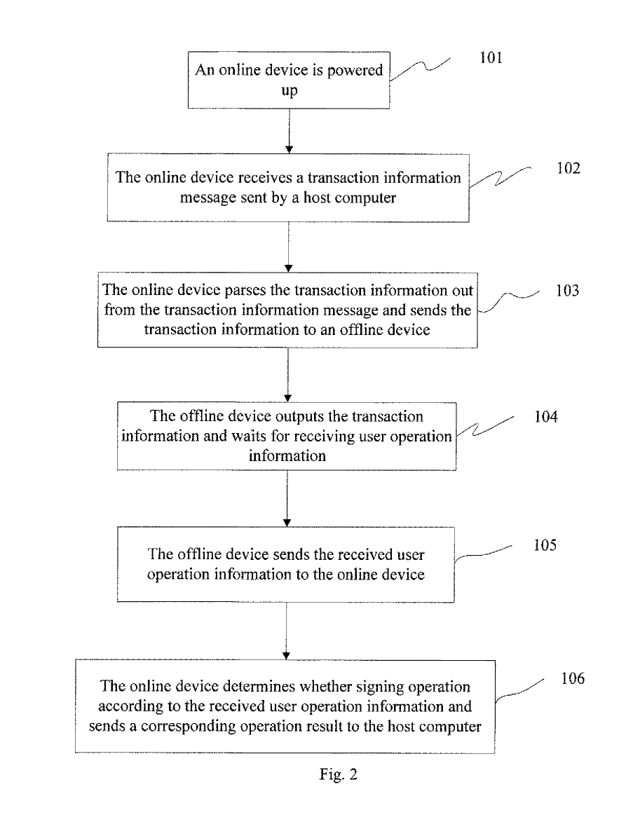

As shown by FIG. 2, the embodiment provides a signing method of a wireless smart key device, which includes following steps:

Step 101, an online device is powered up;

Step 102, the online device receives a transaction information message sent by a host computer;

Step 103, the online device parses the transaction information out from the transaction information message and sends the transaction information to an offline device; the online device can send the transaction information to the offline device by wireless connection or wired connection;

Step 104, the offline device outputs the transaction information and waits for receiving user operation information;

Step 105, the offline device sends the received user operation information to the online device; and

Step 106, the online device determines whether to perform signing operation according to the received user operation information, and sends a corresponding operation result to the host computer.

### Embodiment 3

In the embodiment, the description is made in detail by taking the case that the serial communication interface of the wireless smart key device is a USB interface as an example.

The step 101 that an online device is powered up in embodiment 2 can specifically be step 101-1: the online device is connected to the host computer by a USB interface, the user inputs identity verification code to the client side of the host computer, the host computer verifies whether the identity verification code input by the user is correct, if yes, the host computer sends the transaction information message to the online device, otherwise, the host computer and the online device do not perform data interaction.

Specifically, the step 101 can be step 101-2: the online device establishes wired connection to the offline device by a first connecting line and a second connecting line; the online device is connected to the host computer by a USB interface; the host computer sends the transaction information message to the online device; and then step 102 is executed.

Further, after the online device establishes wired connection to the offline device, a process of generating a communication key by an agreement may also be included.

Further, after the online device is connected to the host computer by the USB interface, a process of identity verification with the host computer may also be included, if the verification is successful, go to step 102, otherwise, no data interaction is performed between the online device and the host computer.

The process of generating the communication key by the agreement can be: the online device sends a solidified array to the offline device and keeps the solidified array by itself; the offline device receives the solidified array and takes it as the key generated by the agreement; or the online device and the offline device keep the solidified key of themselves respectively; the online device generates a random number, and sends the random number and the solidified key to the offline device; the offline device compares the received solidified key with a pre-stored solidified key; if they are consistent, the pre-stored solidified key is replaced with the received random number, and the random number is stored in a non-volatile memory as a new communication key generated by the agreement, and the online device also replaces the original solidified key with the random number.

The communication key generated by the agreement between the online device and the offline device can be used for pairing the online device and the offline device, and also can be used for encrypting data transferred between the online device and the offline device.

Specifically, the step 101 can be step 101-3: the online device and the offline device perform pairing by wireless connection, the online device is connected to the host computer by a USB interface; if the pairing is successful, go to step 102, otherwise, the host computer receives feedback that the pairing is failed, and the transaction information message is not sent to the online device.

Specifically, the step 101 and the step 102 can be step 101-4: the online device is connected to the host computer by the USB interface; the online device receives the transaction information message sent by the host computer; the online device and the offline device perform pairing by wireless connection; if the pairing is successful, the online device and the offline device can receive and send data with each other, otherwise, the step 103 is not executed.

The pairing above can be: the online device selects a fixed number from a fixed array stored in the memory and sends the fixed number to the offline device; the offline device receives the fixed number and searches in the pre-stored fixed array to determine whether a fixed number in the fixed array matches the fixed number received; if yes, the pairing is successful; otherwise no data interaction is performed between the online device and the offline device. Or if a multi-byte fixed number is pre-written in the memories of the offline device and the online device respectively, the online device sends the fixed number to the offline device for pairing; for each time of successful pairing, the multi-byte fixed number performs self-increase and then is stored in its original memories respectively. By using the method of self-increase of the fixed number to perform pairing, all of the numbers used for each time of pairing keep changing by the form of self-increase.

The pairing above can be: the online device generates a random number and computes the random number with a predetermined algorithm to generate a first value, the online device sends the random number and the first value to the offline device, the offline device computes the received random number with the predetermined algorithm to generate a second value, the offline device compares the first value and the second value, if they are consistent, the pairing is successful, otherwise, the pairing is failed. The predetermined algorithm can be MD5, SHA1, etc.

The pairing above can be: the online device and the offline device perform pairing by using the communication key generated by the agreement of the step 101-2.

The pairing above can also be: the online device generates a random number and sends the random number and a pre-stored fixed number to the offline device, the offline device compares the received fixed number with the pre-stored fixed number, if they are consistent, the pairing is successful and the online device replaces the pre-stored fixed number with the sent random number, and the offline device also replaces the pre-stored fixed number with the received random number.

The process of pairing can be actively initiated by the online device to the offline device or by the offline device to the online device.

The random number or the fixed array used for the pairing is stored in the memories of the online device or the offline device, the memory is non-volatile memory, such as FLASH, E2PROM, etc.

### Embodiment 4

The step 103 that the online device parses the transaction information message to obtain transaction information and sends the transaction information to the offline device in embodiment 2 can specifically be step 103-1: the online device receives the transaction information message, parses the transaction information message according to a predetermined rule and extracts the transaction information from the transaction information message, the online device sends the transaction information to the offline device by wired connection or wireless connection and waits for the offline device returning corresponding response.

The predetermined parsing rule is not in the scope of the present disclosure. Specifically, in the present embodiment, the predetermined transaction information message is transaction message based on XML. For example, the transaction information message is as follows:

<?xml version=“1.0”
encoding=“UTF-8”?><T><D><M><k>_Beneficiary's Name :
</k><v> Zhang San </v></M><M><k>Amount :
</k><v>123.23</v></M></D><E><M><k> Serial
number : </k><v>12345678</v></M></E></T>.

Correspondingly, the transaction information extracted from the transaction information message is

Beneficiary's Name: Zhang San

Amount: 123.23

Further, the online device can encrypt the transaction information and send the encrypted transaction information to the offline device by wired connection or wireless connection. The encryption can adopt encryption with solidified key or the communication key generated by an agreement of the online device and the offline device.

If waiting time of the online device exceeds a predetermined time limit, the online device sends a “cancel for time out” instruction to the offline device.

Specifically, the step 103 that the online device parses the transaction information message to obtain transaction information and sends the transaction information to the offline device can be step 103-2: the online device receives the transaction information message; parses the transaction information message according to a predetermined rule and extracts the transaction information from the message; further extracts key information in the transaction information and sends the key information to the offline device and waits for the offline device returning corresponding response. If the waiting time exceeds a predetermined time limit, the online device sends “cancel for time out” instruction to the offline device.

Specifically, the step 103 that the online device parses the transaction information message to obtain transaction information and sends the transaction information to the offline device can be step 103-3: the online device receives the transaction information message and parses the transaction information message according to a predetermined rule, extracts the transaction information from the transaction information message, sends the transaction information to the offline device, and waits for response from the offline device about whether receiving the transaction information is successful or not, if a return code of successful receiving returned from the offline device is received, the online device sends an instruction of detecting key status to the offline device, and waits for the offline device returning corresponding response; if the waiting time exceeds a predetermined time limit, the online device sends the “cancel for time out” instruction to the offline device.

### Embodiment 5

The step 104 and the step 105 of embodiment 2 specifically can be step 1045-1: the offline device outputs the received transaction information and waits for receiving user operation information, if the received user operation information is confirming information, the offline device sends a return code of “confirming signing” to the online device; if the received user operation information is cancelling information, the offline device sends a return code of “cancelling signing” to the online device; if no user operation information is received in a predetermined time, the offline device sends a return code of “cancel for time out” to the online device.

Specifically, the step 104 and the step 105 can be step 1045-2: the offline device receives the transaction information and sends a return code of successful receiving to the online device, and the offline device outputs the received transaction information, when the offline device receives instruction of inquiring key status sent from the online device, the offline device checks whether any key of the information inputting module is pressed, if a confirming key is pressed, the offline device sends return code of “confirming key” to the online device; if cancelling key is pressed, the offline device sends a return code of “cancelling key” to the online device; if no pressing key information is received in a predetermined time, the offline device sends a return code of “waiting key” to the online device.

Further, it can be set that when the confirming key is pressed twice or more, the offline device sends a confirming instruction of “permitting signing” to the online device.

Specifically, the step 104 and the step 105 can be step 1045-3: the offline device outputs the transaction information, and waits for inputting information from a user; the offline device checks wired connection status of the online device, if the offline device detects one time of wired connection to the online device, it determines that the received user operation information is confirming information; if the offline device does not detect any wire connection to the online device in the predetermined time, it determines that the received user operation information is cancelling information; the offline device sends the confirming information or the cancelling information to the online device.

In the embodiment, the offline device can display the transaction information by a liquid crystal display or broadcast the transaction information by a voice announcer; the user can input the user operation information by keys or voice and the like. The offline device can send the user operation information to the online device by wired connection or wireless connection.

### Embodiment 6

The step 106 that the online device determines whether performing signing operation according to the received user operation information, and sends corresponding operation result to the host computer in embodiment 2 specifically can be step 106-1; if the user operation information received by the online device is confirming information, the online device computes and signs the transaction information message, and sends the signing result to the host computer; if the user operation information received by the online device is cancelling information, the online device sends a return code of “cancelling signing” to the host computer.

Further, when the online device receives “cancel for time out”, the online device sends a return code of “cancel signing” to the host computer.

The online device computing and signing the transaction information message can be that the online device signs the whole transaction information message or part of the transaction information message. For example, if the content of the transaction information message is long, the online device can intercept key content in the transaction information, calculate digest of the key content and encrypt the digest with a private key, then the online device sends the encrypted digest and the transaction information message to the host computer.

### Embodiment 7

In embodiment 7, the security module of the wireless smart key device is located in the offline device; the information inputting module and the information outputting module which are used for rechecking the transaction data are also in the offline device; the online device and the offline device can communicate with each other by wireless connection or wired connection.

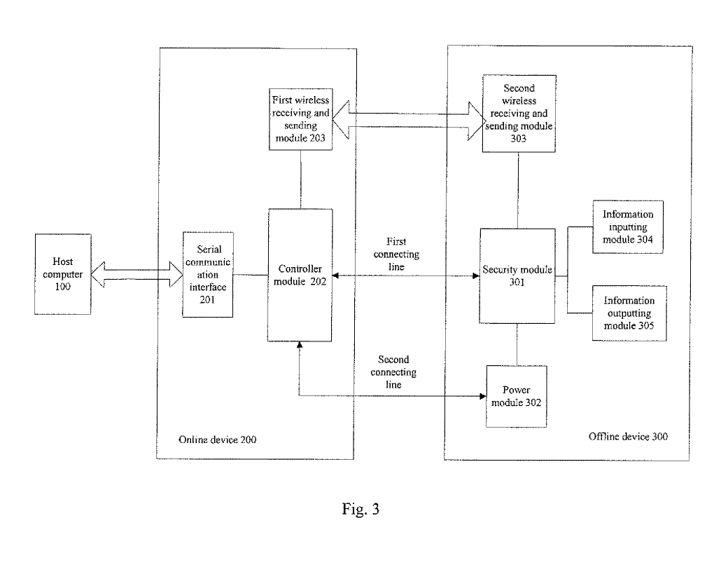

As shown by FIG. 3, the wireless smart key device includes an online device 200 and an offline device 300. The online device 200 includes a serial communication interface 201, a controller module 202 and a first wireless receiving and sending module 203. The offline device 300 includes a security module 301, a power module 302, a second wireless receiving and sending module 303, an information inputting module 304 and an information outputting module 305. In the online device 200, the serial communication interface 201 and the first wireless receiving and sending module 202 are connected to the controller module 202 respectively. In the offline device 300, the security module 301 is connected to the power module 302, the second wireless receiving and sending module 303, the information inputting module 304 and the information outputting module 305 respectively. The power module 302 can be an external power interface. The external power interface is connected to the host computer to obtain power so as to supply power to the offline device.

Further, the controller module 202 of the online device 200 can be connected to the security module 301 of the offline device 300 by a first connecting line and be connected to the power module 302 of the offline device 300 by a second connecting line. The first wireless receiving and sending module 203 and the second wireless receiving and sending module 303 can adopt nRF24L01+2.4G radio frequency receiver.

The functions of each module above are as follows.

The serial communication interface 201 is configured to receive data sent from the host computer, transfer the data to the controller module 202, and send the data transferred from the controller module 202 to the host computer. The serial communication interface 201 can be USB interface, serial interface, eSATA interface, 1394 interface, PCI_E interface, etc.

The controller module 202 is configured to control data transmission between the controller module 202 and the serial communication interface 201, and control the first wireless receiving and sending module 203 to receive and send data.

The first wireless receiving and sending module 203 is configured to receive data transferred from the controller module 202 and send the data to the second wireless receiving and sending module 303, and transfer the data received by the second wireless receiving and sending module 303 to the controller module 202.

The security module 301 is configured to receive data transferred from the second wireless receiving and sending module 303, parse the transaction information message, send the transaction information to the information outputting module 305, receive the user operation information transferred from the information inputting module 304, sign the transaction information message, send signing result to the second wireless receiving and sending module 303 and store the key.

The power module 302 is configured to supply power to the offline device and can supply power by adopting cells directly. The power module 302 also can be an external power interface, which is connected to the host computer so as to supply power to the offline device. The external power interface can be serial interface, USB interface, etc. The power module 302 is connected to the power side of the security module 301 by the second connecting line, and in the case of wired connection, the power module 302 can obtain power from the online device and supply power to the offline device.

The second wireless receiving and sending module 303 is configured to receive the data sent by the first wireless receiving and sending module 203 and transfer the data to the security module 301 and send the data transferred from the security module 301 to the first wireless receiving and sending module 203;

The information inputting module 304 is configured to receive the user operation information and transfer the user operation information to the controller module 202 by way of pressing key or inputting voice, and the like.

The information outputting module 305: is configured to receive the transaction information transferred from the controller module 202 and output the transaction information; the information outputting module 305 can be a liquid crystal display, a voice announcer, etc.

### Embodiment 8

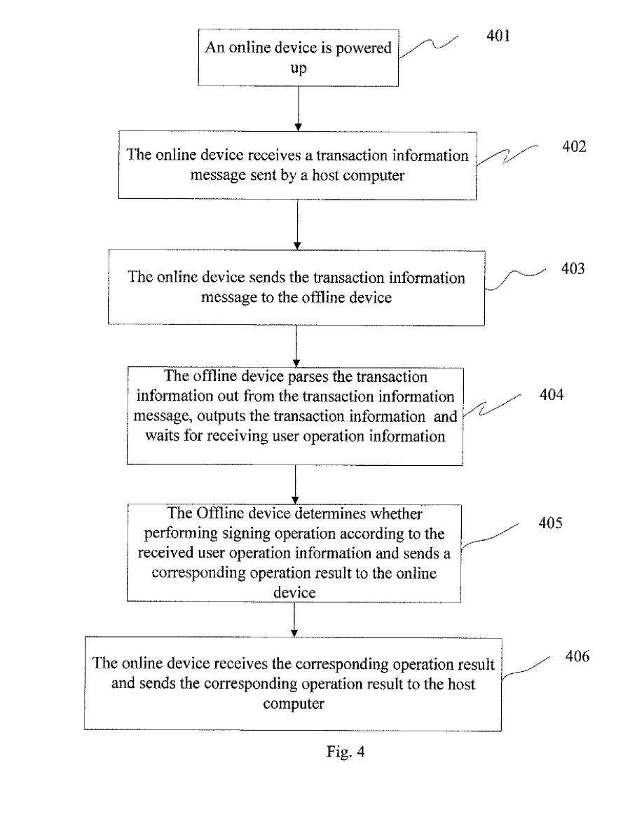

As shown by FIG. 4, a signing method of a wireless smart key device provided by embodiment 8 includes following steps:

step 401: an online device is powered up;

step 402: the online device receives a transaction information message sent by the host computer;

step 403: the online device sends the transaction information message to the offline device;

step 404: the offline device parses the transaction information out from the received transaction information message, the offline device outputs the transaction information, and waits for receiving user operation information;

step 405: the offline device determines whether performing signing operation according to the received user operation information, and sends a corresponding operation result to the online device; and

step 406: the online device receives corresponding operation result and sends the corresponding operation result to the host computer.

### Embodiment 9

Specifically, in embodiment 9, it is described in details in the condition that the serial communication interface of the wireless smart key device is a USB interface.

The step 401 that the online device is powered up in the embodiment 8 can specifically be step 401-1: the online device is connected to the host computer by a USB interface; a user inputs identity verification code to the client side of the host computer; the host computer verifies whether the identity verification code input by the user is correct, if yes, the host computer sends the transaction information message to the online device, otherwise, the host computer and the online device do not perform data interaction.

Specifically, the step 401 can be step 401-2: the online device establishes wired connection with the offline device by a first connecting line and a second connecting line, the online device is connected to the host computer by the USB interface, the host computer sends the transaction information message to the online device, and then the step 402 is executed;

Further, after the online device establishes connection to the offline device, a process of generating communication key by an agreement is further included.

Further, after the online device establishes connection to the host computer by the USB interface, the process of identity verification with the host computer is further included, and if the verification is successful, go to the step 402, otherwise, no data interaction is performed between the online device and the host computer.

The process of generating the communication key by the agreement can be: the online device sends a solidified array to the offline device and keeps the solidified array by itself; the offline device receives the solidified array and takes it as the key generated by the agreement; or the online device and the offline device keep the solidified key of themselves respectively; the online device generates a random number, and sends the random number and the solidified key to the offline device; the offline device compares the received solidified key with a pre-stored solidified key, if they are consistent, the pre-stored solidified key is replaced with the received random number, and the random number is stored in the non-volatile memory as new communication key generated by the agreement; the online device also replaces the original solidified key with the random number;

The communication key generated by the agreement between the online device and the offline device can be used for pairing the online device and the offline device, and also can be used for encrypting data transferred between the online device and the offline device.

The step 401 can specifically be step 401-3: the online device and the offline device perform pairing by wireless connection; the online device is connected to the host computer by the USB interface, if the pairing is successful, go to the step 102; otherwise, the host computer receives feedback that the pairing is failed, and does not send the transaction information message to the online device.

The step 401 and step 402 can specifically be step 401-4: the online device is connected to the host computer by the USB interface; the online device receives the transaction information message sent by the host computer; the online device and the offline device perform pairing by wireless connection, and if the pairing is successful, the online device and the offline device can receive and send data with each other; otherwise, the step 403 is not executed;

The above pairing can be: the online device selects a fixed number from a fixed array stored in the memory and sends the fixed number to the offline device; the offline device receives the fixed number and searches in the pre-stored fixed array to determine whether a fixed number in the fixed array matches the fixed number received; if yes, the pairing is successful; otherwise, no data interaction is performed between the online device and the offline device. Or if a multi-byte fixed number is pre-written in the memories of the online device and the offline device respectively, the online device sends the fixed number to the offline device for pairing; for each time of successful pairing, the multi-byte fixed number performs self-increase and then is stored in its original memories respectively. By using the method of self-increase of the fixed number to perform pairing, all of the numbers used for each time of pairing keep changing by the form of self-increase.

The pairing above can be: the online device generates a random number and computes the random number with predetermined algorithm to generate a first value; the online device sends the random number and the first value to the offline device; the offline device computes the received random number with the predetermined algorithm to generate a second value; the offline device compares the first value and the second value, if they are consistent, the pairing is successful; otherwise, the pairing is failed. The predetermined algorithm can be MD5, SHA1, etc.

The pairing above can be: the online device and the offline device perform pairing by using the communication key generated by the agreement of the step 401-2.

The pairing above further can be: the online device generates a random number and sends the random number and a pre-stored fixed number to the offline device; the offline device compares the received fixed number with the pre-stored fixed number, if they are consistent, the pairing is successful and the online device replaces the pre-stored fixed number with the sent random numbers, and the offline device also replaces the pre-stored fixed number with the received random number.

The process of pairing can be actively initiated by the online device to the offline device or by the offline device to the online device.

The random number or the fixed array used for pairing is stored in the memories of the online device or the offline device. The memory is non-volatile memory, such as FLASH, E2PROM, etc.

### Embodiment 10

The step 403 that the online device sends the transaction information message to the offline device specifically in embodiment 8 can be step 403-1 the online device sends transaction information message to the offline device and waits for response about whether receiving the transaction information successfully or not from the offline device, if a return code of successful receiving returned from the offline device is received, the online device sends an instruction of detecting key status to the offline device, and waits for the offline device returning corresponding response; if the waiting time exceeds a predetermined time limit, the online device sends a “cancel for time out” instruction to the host computer.

Specifically, the step 403 further can be: the online device sends the transaction information message to the offline device, and waits for the offline device returning corresponding operation result;

The online device can send the transaction information message to the offline device by way of wireless connection or wired connection; further, the online device can encrypt the transaction information message and send the encrypted transaction information message to the offline device; preferably, the transaction information message is encrypted by solidified key or a communication key generated by an agreement of the online device and the offline device which are connected by wire.

### Embodiment 11

The step 404 that the offline device parses the transaction information out from the received transaction information message; the offline device outputs the transaction information and waits for receiving user operation information in embodiment 8 can be step 404-1: the offline device receives the transaction information message; the security module parses the transaction information message according to a predetermined rule and extracts the transaction information from the transaction information message; the offline device outputs the transaction information by the information outputting module and waits for user operation information.

The predetermined parsing rule is not in the scope of the present disclosure. Specifically, in the present embodiment, the predetermined transaction information message is the transaction message based on XML, for example, the transaction information message is

<?xml version=“1.0”
encoding=“UTF-8”?><T><D><M><k> Beneficiary's
Name : </k><v>Zhang San</v></M><M><k>
Amount : </k><v>123.23</v></M></D><E><M><k>
Serial number : </k><v>12345678</v></M></E></T>

Correspondingly, the transaction information extracted from the transaction information message is

Beneficiary's Name: Zhang San

Amount: 123.23

Specifically, the offline device waiting for receiving the user operation information is: the offline device checks whether any key of the information inputting module is pressed, if a confirming key is pressed, it is determined that the received user operation information is confirming information; if a cancelling key is pressed, it is determined that the received user operation information is cancelling information. Further, it can be set that when the confirming key is pressed twice or more, the user operation information received by the offline device is confirming information.

In embodiment 11, the offline device can display the transaction information by a liquid crystal display or broadcast the transaction information by a voice announcer; a user can input user operation information by pressing keys or inputting voice, and the like.

### Embodiment 12

The step 405 that the offline device determines whether performing signing operation according to the received user operation information, and sends corresponding operation result to the online device in embodiment 8 specifically can be step 405-1: if the user operation information received by the offline device is confirming information, the offline device computes the transaction information message for signing, and sends the signing result to the online device; if the user operation information received by the offline device is cancelling information, the offline devices sends instruction of cancelling signing to the online device; if the offline device does not receive the user operation information in a predetermined time, the offline device sends a return code of “cancel for time out” to the online device.

Computing the above transaction information message for signing can be computing s the whole transaction information message or part of the transaction information message for signing. For example, when the transaction information message is long, the key content of the transaction information can be intercepted, digest of the key part can be calculated and is encrypted with a private key, and the online device sends the encrypted digest and the transaction information message to the host computer.

The signing result, the instruction of cancelling signing or the return code of “cancel for time out” sent from the online device to the host computer can be transferred by wired connection or wireless connection.

The embodiments described above are the preferred specific embodiments only. Any modification and equivalent substitute made by those skilled in the art in the scope of the technical solution of the present disclosure should fall into the protection scope of the present disclosure.

1. A wireless smart key device comprising an online device and an offline device, wherein the online device comprises a serial communication interface, a first module and a first wireless receiving and sending module; the offline device comprises a second module, a power module, a second wireless receiving and sending module, an information inputting module and an information outputting module;
the serial communication interface is connected to the first module and is configured to receive data sent by a host computer, transfer the data to the first module and send the data transferred from the first module to the host computer;
the first wireless receiving and sending module is connected to the first module and is configured to send transaction information transferred from the first module to the second wireless receiving and sending module and transfer the data sent from the second wireless receiving and sending module to the first module;
the second wireless receiving and sending module is connected to the second module and is configured to transfer the transaction information sent by the first wireless receiving and sending module to the second module and send data transferred from the second module to the first wireless receiving and sending module;
the information inputting module is connected to the second module and is configured to receive user operation information and transfer the user operation information to the second module;
the information outputting module is connected to the second module and is configured to receive the transaction information transferred from the second module and output the transaction information;
the power module is connected to the second module and is configured to supply power to the offline device; wherein
when the first module is a security module and the second module is a controller module, the security module is configured to receive data transferred from the serial communication interface, parse the received transaction information message, send the transaction information to the first wireless receiving and sending module, receive the data transferred from the first wireless receiving and sending module, sign the transaction information message and send a signing result to the serial communication interface and store a key; the controller module is configured to control the second wireless receiving and sending module to receive and send data, transfer the transaction information received from the second receiving and sending module to the information outputting module and transfer the user operation information transferred from the information inputting module to the second wireless receiving and sending module,
or,
when the first module is the controller module, the second module is the security module, the controller module is configured to control data transmission with the serial communication interface and control the first wireless receiving and sending module to receive and send data; the security module is configured to receive data transferred from the second wireless receiving and sending module, parse the transaction information message, send the transaction information to the information outputting module, receive the user operation information transferred from the information inputting module, sign the transaction information message, send a signing result to the second wireless receiving and sending module and store a key.

2. The wireless smart key device of claim 1, wherein the first module is connected to the second module by a first connecting line and is connected to the power module by a second connecting line.

3. A signing method of a wireless smart key device, comprising:
step 101, an online device being powered up;
step 102, the online device receiving a transaction information message sent by a host computer;
step 103, the online device communicating with an offline device, and the offline device obtaining transaction information;
step 104, the offline device outputting the transaction information, and waiting for receiving user operation information;
step 105, the offline device receiving the user operation information;
step 106, the offline device communicating with the online device, and the online device obtaining an operation result of processing the user operation;
step 107, the online device sending the corresponding operation result to the host computer,
wherein
the step 103 comprises step S103′ which is: the online device parsing the transaction information out from the transaction information message, the online device sending the transaction information to the offline device, the offline device obtaining the transaction information; correspondingly, the step 106 comprises step S106′ which is: the offline device sending the received user operation information to the online device; the online device determining whether performing a signing operation according to the received user operation information,
or,
the step 103 comprises step S103″ which is the online device sending the transaction information message to the offline device, the offline device parsing the transaction information out from the received transaction information message, the offline device obtaining the transaction information; correspondingly, the step 106 comprises step S106″: the offline device determining whether performing signing operation according to the received user operation information, the offline device sending a corresponding operation result to the online device.

4. The signing method of claim 3, wherein before the step 103, the method further comprises: the online device establishing wired connection to the offline device by a first connecting line and a second connecting line; the online device being connected to the host computer by a serial communication interface and receiving the transaction information message sent by the host computer.

5. The signing method of claim 3, wherein before the step 101, the method further comprises: the online device establishing wired connection to the offline device, the online device and the offline device generating a communication key by an agreement, wherein
the process of generating the communication key by the agreement comprises that the online device stores a solidified array and sends the solidified array to the offline device; the offline device receives the solidified array as the communication key generated by the agreement; or
the online device generates a random number and sends the random number and a pre-stored solidified key to the offline device; the offline device compares the received solidified key with its own pre-stored solidified key, if they are consistent, the offline device replaces the pre-stored solidified key with the received random number and takes the random number as a communication key generated by the agreement, the online device also replaces its own pre-stored solidified key with the random number.

6. The signing method of claim 3, wherein before the step 102, the method further comprises process of identity verification.

7. The signing method of claim 3, wherein before the step 103, the method further comprises that the online device is connected to the offline device by wireless connection.

8. The signing method of claim 7, wherein after the online device is connected to the offline device by wireless connection, the method further comprises process of pairing.

9. The signing method of claim 8, wherein the process of pairing can be that the online device actively initiates pairing to the offline device or the offline device actively initiates pairing to the online device, wherein
the process that the online device actively initiates pairing to the offline device comprises that the online device selects a fixed number from a pre-stored fixed array and sends the fixed number to the offline device; the offline device receives the fixed number and searches for a fixed number, which matches the received fixed number, in its own pre-stored fixed array; if the fixed number is found, the pairing is successful, otherwise, the pairing is failed; wherein the fixed number is a multi-byte fixed number the multi-byte fixed number performs self-increase by 1 for each time of pairing to form a new fixed number and the new fixed number is stored; or
the process that the online device actively initiates pairing to the offline device comprises that the online device generates a random number, and computes the random number with predetermined algorithm to generate a first value; the online device sends the random number and the first value to the offline device; the offline device computes the received random number with predetermined algorithm to generate a second value; the offline device compares the first value with the second value, if they are consistent, the pairing is successful, otherwise, the pairing is failed; or
the process that the online device actively initiates pairing to the offline device comprises that the online device generates a random number, and sends the random number and a pre-stored fixed number to the offline device; the offline device compares the received fixed number with its own pre-stored fixed number; if they are consistent, the pairing is successful, and the online device replaces the fixed number pre-stored by the online device with the sent random number, the offline device replaces the fixed number pre-stored by the offline device with the received random number, if they are not consistent, the pairing is failed.

10. The signing method of claim 8, wherein the process of pairing adopts the communication key generated by the agreement of the online device and the offline device which are connected by wire.

11. The signing method of claim 3, wherein the step S103′ comprises: the security module of the online device parsing the transaction information out from the transaction information message according to a predetermined rule; the online device adopting encryption to send the transaction information to the offline device, the online device waiting for the offline device returning a corresponding response.

12. The signing method of claim 3, wherein when the step 103 comprises the step S103′, the step 104 and the step 105 comprise: the offline device outputting the received transaction information, and waiting for receiving the user operation information, if it is determined that the user operation information received by the offline device is confirming information, the offline device sending a return code of “confirming signing” to the online device; if it is determined that the user operation information received by the offline device is cancelling information, the offline device sending a return code of “cancelling signing” to the online device; if the offline device does not receive the user operation information in a predetermined time, the offline device sending a return code of “cancel for time out” to the online device.

13. The signing method of claim 3, wherein when the step 103 comprises the step S103′, the step 104 and the step 105 comprise: the offline device receiving the transaction information, sending a return code of successful receiving to the online device and outputting the received transaction information; when the offline device receives an instruction of inquiring key status sent from the online device, the offline device checking whether any key of the information inputting module is pressed, and if a confirming key is pressed, the offline device sending a return code of “confirming key” to the online device; if a cancelling key is pressed, the offline device sending a return code of “cancelling key” to the online device; if no key information is received in a predetermined time, the offline device sending a return code of “waiting for pressing key” to the online device, wherein when the confirming key is pressed twice or more, the offline device sends an confirming instruction of “permitting signing” to the online device.

14. The signing method of claim 3, wherein when the step 103 comprises the step S103′, the step 104 and the step 105 comprise: the offline device outputting the transaction information, waiting for receiving user operation information, the offline device checking status of wired connection with the online device, if the offline device detects that the status of wired connection is in process of waiting and the offline device and the online device have once wired connection, the offline device determining that the received user operation information is confirming information, if the offline device does not detect wired connection with the online device in a predetermined time, the offline device determining that the received user operation information is cancelling information; the offline device sending the confirming information or the cancelling information to the online device.

15. The signing method of claim 3, wherein the step S106′ comprises: if the user operation information received by the online device is confirming information, the security module computes whole transaction information message or part of the transaction information message for signing, and the online device sending a signing result to the host computer; if the user operation information received by the online device is cancelling information, the online device sending a return code of “cancelling signing” to the host computer.

16. The signing method of claim 3, wherein the step S103″ comprises: the online device sending the transaction information message to the offline device and waiting for the response about whether successful receiving the transaction information message or not returned by the offline device; when a return code of successful receiving returned from the offline device is received, the online device sending an inquiring signing instruction to the offline device and waiting for the offline device returning a corresponding response;
or,
the step S103″ comprises: the online device sending the transaction information message by encryption to the offline device and waiting for the offline device returning a corresponding operation result, wherein the way of encryption adopts a solidified key or a communication key generated by an agreement of the online device and the offline device when they are connected by wire to encrypt the transaction information message.

17. The signing method of claim 3, wherein when the step 103 comprises the step S103″, the step 103 and the step 104 comprise: the offline device receiving the transaction information message sent by the online device, a security module in the offline device parsing the transaction information out from the transaction information message according to a predetermined rule, an information outputting module of the offline device outputting the transaction information, and the offline device waiting for receiving the user operation information.

18. The signing method of claim 3, wherein when the step 103 comprises the step S103″, the offline device waiting for receiving the user operation information in step 104 comprises: the offline device checking whether any key of an information inputting module is pressed, if a confirming key is pressed, the offline device determining that the received user operation information is confirming information; if a cancelling key is pressed, the offline device determining that the received user operation information is cancelling information; or
when the step 103 comprises the step S103″, in the step 104 if the waiting time of the offline device exceeds a predetermined time limit, the offline device sending a return code of “cancel for time out” to the online device.

19. The signing method of claim 3, wherein when the step 106 comprises the step S106″, the step 105 and the step 106 comprises: if the user operation information received by the offline device is confirming information, the offline device performing signing operation and sending a signing result to the online device; if the user operation information received by the offline device is cancelling information or a return code of “cancel for time out”, the offline device sending an instruction of cancelling signing to the online device, wherein the signing operation is that the online device computes the whole transaction information message or part of the transaction information message for signing.
